(19) United States
(12) Patent Application Publication
(10) Pub. No.: US 2014/0226039 A1
(43) Pub. Date: Aug. 14, 2014

(54) IMAGE CAPTURING APPARATUS AND CONTROL METHOD THEREOF

(71) Applicant: CANON KABUSHIKI KAISHA, Tokyo (JP)

(72) Inventors: Satoshi Yamamoto, Tokyo (JP); Toshihiro Mochizuki, Kawasaki-shi (JP); Kenichi Murata, Tokyo (JP)

(73) Assignee: CANON KABUSHIKI KAISHA, Tokyo (JP)

(21) Appl. No.: 14/168,540

(22) Filed: Jan. 30, 2014

(30) Foreign Application Priority Data
Feb. 14, 2013 (JP) 2013-027141

(51) Int. Cl. H04N 5/262

(52) U.S. Cl. CPC H04N 5/2621
USPC 348/239

(57) ABSTRACT

An image capturing apparatus comprises an image capturing unit configured to capture an image and generate light field image data, a selection unit configured to select an object from the captured image data, an associating unit configured to associate a plurality of objects selected by the selection unit, a reconstruction unit configured to reconstruct a plurality of images in which the plurality of objects associated by the associating unit are in focus, respectively, and a composition unit configured to composite the plurality of images reconstructed by the reconstruction unit.

### BACKGROUND OF THE INVENTION

1. Field of the Invention

The present invention relates to an image capturing apparatus capable of reconstructing an image on an arbitrary refocus plane.

2. Description of the Related Art

Recently, among image capturing apparatuses such as an electronic camera, there is proposed an image capturing apparatus (light field camera) capable of acquiring even information of the incident direction of light in addition to the intensity distribution of light.

For example, according to “Ren. Ng and seven others, ‘Light Field Photography with a Hand-Held Plenoptic Camera’, Stanford Tech Report CTSR 2005-02”, a microlens array is interposed between an imaging lens and an image sensor, and one microlens corresponds to a plurality of pixels of the image sensor. Light having passed through the microlens is acquired by the plurality of pixels for respective incident directions. By applying a method called “Light Field Photography” to thus-acquired pixel signals (light field information), images focused on a plurality of image planes (refocus planes) can be reconstructed after shooting.

On the other hand, there is a demand for capturing an image which may give an illusion as to the size relationship between objects by using perspective in image capturing. For example, in a composition in which a person at a short distance appears to support a building at a long distance, as shown in FIG. 17, the depth of field is set to be deep so as to focus on both of the objects. This gives an illusion that the building at a long distance and the person at a short distance exist at the same object distance. Such an image will be called a trick art image.

However, in shooting by a normal image capturing apparatus, the image capturing apparatus cannot focus on both of objects to be used for an illusion, and either object blurs, obtaining only a less effective trick art image.

Further, no proposal has been made for generation of an image such as a trick art image in the above-mentioned light field camera.

When focusing on both objects to be used for an illusion, as described above, if the objects exist outside the in-focus range, they become out of focus. To prevent this, when objects to be used for an illusion exist outside the in-focus range, a means which notifies the user of this is required. However, even such a means has not been considered so far.

### SUMMARY OF THE INVENTION

The present invention has been made to solve the above-described problems, and provides an image capturing apparatus capable of easily reconstructing a trick art image intended by the user.

According to the first aspect of the present invention, there is provided an image capturing apparatus comprising: an image capturing unit configured to capture an image and generate light field image data; a selection unit configured to select an object from the captured image data; an associating unit configured to associate a plurality of objects selected by the selection unit; a reconstruction unit configured to reconstruct a plurality of images in which the plurality of objects associated by the associating unit are in focus, respectively; and a composition unit configured to composite the plurality of images reconstructed by the reconstruction unit.

According to the second aspect of the present invention, there is provided a method of controlling an image capturing apparatus including an image capturing unit configured to capture an image and generate light field image data, comprising: a selection step of selecting an object from the captured image data; an associating step of associating a plurality of objects selected in the selection step; a reconstruction step of reconstructing a plurality of images in which the plurality of objects associated in the associating step are in focus, respectively; and a composition step of compositing the plurality of images reconstructed in the reconstruction step.

Further features of the present invention will become apparent from the following description of exemplary embodiments with reference to the attached drawings.

### BRIEF DESCRIPTION OF THE DRAWINGS

FIG. 1 is a block diagram showing the arrangement of an image capturing apparatus according to the first embodiment of the present invention;

FIG. 2 is a view for explaining the arrangement of an image sensor and microlens array;

FIG. 3 is a view for explaining the arrangement of an imaging lens, microlens array, and image sensor;

FIGS. 4A and 4B are views for explaining the correspondence between pupil areas of the imaging lens and light receiving pixels;

FIG. 5 is a graph for explaining an area through which a light field image generation beam passes;

FIG. 6 is a view showing the distance relationship between the image capturing apparatus and objects when capturing a trick art image;

FIG. 7 is a view showing a trick art image to be acquired;

FIG. 8 is a flowchart showing an operation of capturing images to be used for a trick art;

FIG. 9 is a view showing a method of selecting an object on an electronic viewfinder (EVF);

FIG. 10 is a view showing coordinate information held when an object is selected;

FIG. 11 is a flowchart showing an operation in playback;

FIG. 12 is a view showing an object area detection method;

FIGS. 13A to 13C are views showing images obtained in the first embodiment;

FIG. 14 is a flowchart showing an operation of reconstruction into a trick art in playback;

FIG. 15 is a view for explaining another arrangement of the imaging lens, microlens array, and image sensor;

FIG. 16 is a block diagram showing another example of the whole image capturing apparatus;

FIG. 17 is a view showing an example of a trick art image;

FIG. 18 is a flowchart showing an operation of capturing a trick art image and displaying a warning;

FIG. 19 is a view showing an example of a warning display;

FIG. 20 is a view for explaining an example of a situation in which an object cannot be in focus; and

FIG. 21 is a flowchart showing an operation of reconstructing a trick art image in playback and displaying a warning.

### DESCRIPTION OF THE EMBODIMENTS

Embodiments of the present invention will now be described in detail with reference to the accompanying drawings.

### First Embodiment

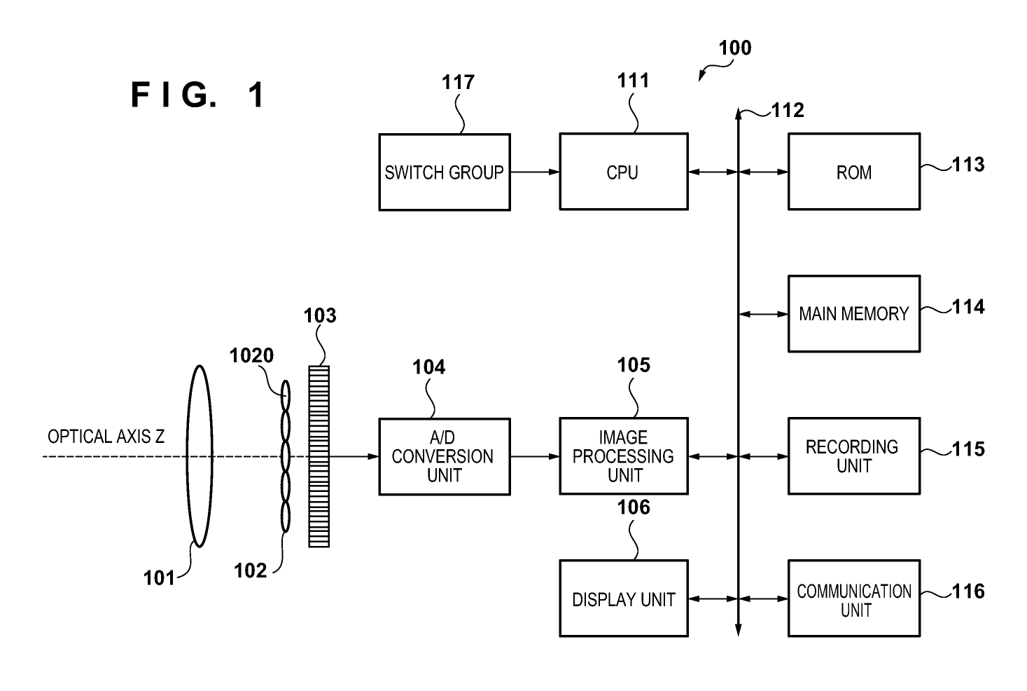

FIG. 1 is a block diagram showing the arrangement of an image capturing apparatus according to the first embodiment of the present invention. In FIG. 1, a switch group (operation member group) 117 outputs, to a CPU 111, various kinds of information about image capturing such as the setting of an image capturing mode. A signal output from a release switch serves as an AE (Auto Exposure) or AF (Auto Focus) operation start trigger or image capturing start trigger. Upon receiving these start triggers, the CPU 111 controls the respective units of an image capturing apparatus 100 including an image sensor 103 and display unit 106. A ROM 113 stores programs and data for the operation of the CPU 111.

Reference numeral 101 denotes an imaging lens; 102, a microlens array; and 103, the image sensor. The microlens array 102 is constructed by a plurality of microlenses 1020. The image sensor 103 converts light, which has entered it via the microlenses 1020, into an electrical signal, and outputs the electrical signal to an A/D conversion unit 104.

The A/D conversion unit 104 digitizes the electrical signal, and outputs the digital data to an image processing unit 105. The image processing unit 105 performs various image generation processes such as white balance correction and color conversion, compression processing of compressing a generated image, composition processing of compositing a plurality of images, and object area detection processing and coordinate information association processing (to be described later). The processed image data is temporarily stored in a main memory 114 via a bus 112. The stored image data is recorded on an external recording medium (not shown) via a recording unit 115, or transmitted to an external apparatus (not shown) such as a personal computer via a communication unit 116. The display unit 106 displays the user interface screen of the image capturing apparatus, is used as an EVF, or displays a captured image.

The embodiment assumes that the image processing unit 105 has a function of performing calculation processing using a method called “Light Field Photography”, and reconstructing an image on an arbitrary refocus plane from captured image data.

Next, the arrangement of the imaging lens 101, microlens array 102, and image sensor 103 when acquiring a light field image will be explained.

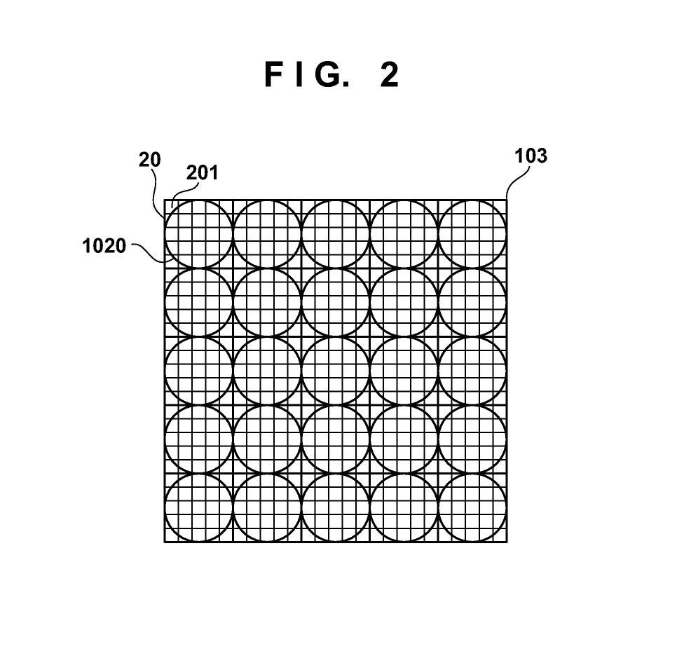

FIG. 2 is a view showing the image sensor 103 and microlens array 102 when observed from the optical axis Z in FIG. 1. One microlens 1020 is arranged to correspond to a plurality of unit pixels 201. The plurality of unit pixels 201 behind one microlens will be defined to form a pixel array 20. The embodiment assumes that the pixel array 20 includes 5×5=25 unit pixels 201 in total.

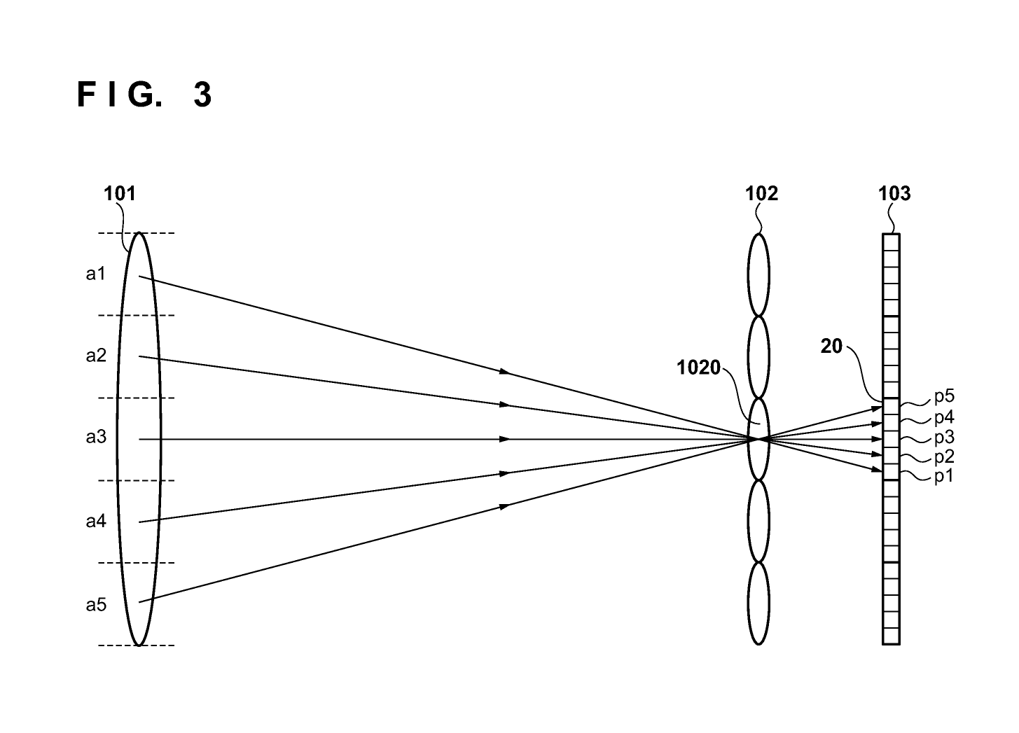

FIG. 3 is a view showing a state in which light emerging from the imaging lens 101 passes through one microlens 1020 and is received by the image sensor 103, when observed from a direction perpendicular to the optical axis Z. Beams which emerge from pupil areas a1 to a5 of the imaging lens 101 and pass through the microlens 1020 form images in corresponding unit pixels p1 to p5 behind.

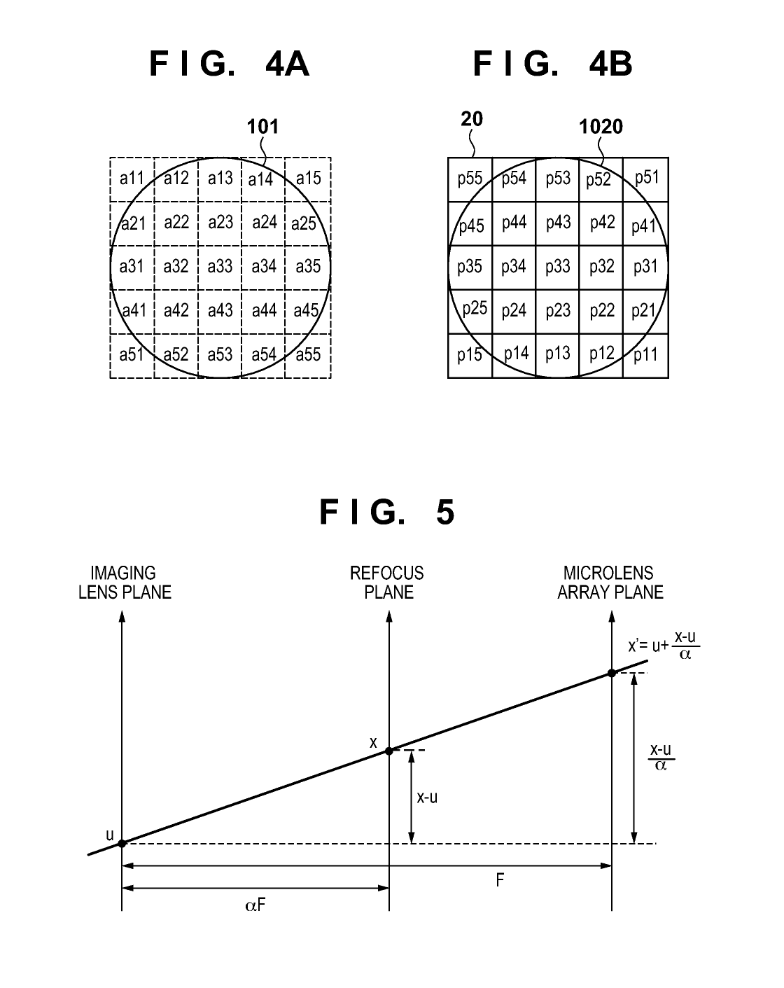

FIG. 4A is a view showing the opening of the imaging lens 101 when viewed from the optical axis Z. FIG. 4B is a view showing one microlens 1020 and the pixel array 20 arranged behind it when viewed from the optical axis Z. When the pupil area of the imaging lens 101 is divided into areas equal in number to pixels behind one microlens, as shown in FIG. 4A, light emerging from one pupil division area of the imaging lens 101 forms an image in one pixel. Assume that the imaging lens 101 and microlens 1020 have almost the same f-number.

The correspondence between pupil division areas a11 to a55 of the imaging lens 101 shown in FIG. 4A and pixels p11 to p55 shown in FIG. 4B is point-symmetrical when viewed from the optical axis Z. Hence, light emerging from the pupil division area all of the imaging lens 101 forms an image in the pixel p11 in the pixel array 20 behind the microlens. Similarly, light which emerges from the pupil division area all and passes through another microlens 1020 also forms an image in the pixel p11 in the pixel array 20 behind this microlens.

A method of calculating a refocus plane corresponding to an arbitrary object position in the frame will be explained.

As described with reference to FIGS. 4A and 4B, the respective pixels of the pixel array 20 receive beams having passed through different pupil areas of the imaging lens 101. By compositing a plurality of pixel signals from these division signals, a pair of signals pupil-divided in the horizontal direction is generated:

$$\begin{matrix}{\sum }_{a = 1}^{5} {\sum }_{b = 1}^{2} ( {p}_{ab} ) & ( 1 ) \\ {\sum }_{a = 1}^{5} {\sum }_{b = 4}^{5} ( {p}_{ab} ) & ( 2 )\end{matrix}$$

Expression (1) integrates beams having passed through the left area (pupil areas a11 to a52) of the exit pupil of the imaging lens 101 for the respective pixels of a given pixel array 20. This is applied to a plurality of pixel arrays 20 aligned in the horizontal direction, and an object image constructed by these output signals is defined as an A image. Expression (2) integrates beams having passed through the right area (pupil areas a14 to a55) of the exit pupil of the imaging lens 101 for the respective pixels of the given pixel array 20. This is applied to a plurality of pixel arrays 20 aligned in the horizontal direction, and an object image constructed by these output signals is defined as a B image. The correlation between the A and B images is calculated to detect an image shift amount (pupil division phase difference). Further, the image shift amount is multiplied by a conversion coefficient determined from the focus position of the imaging lens 101 and the optical system. As a result, a refocus plane corresponding to an arbitrary object position in the frame can be calculated.

Next, processing of reconstructing an image on an arbitrarily set refocus plane from captured image data acquired by the arrangement of the imaging lens 101, microlens array 102, and image sensor 103 will be explained.

FIG. 5 is a graph showing a pupil division area of the imaging lens from which light passing through a given pixel on an arbitrarily set refocus plane emerges, and a microlens the light enters, when viewed from a direction perpendicular to the optical axis Z. In FIG. 5, the position of a pupil division area of the imaging lens is indicated by coordinates (u, v), a pixel position on the refocus plane is indicated by coordinates (x, y), and the position of a microlens on the microlens array is indicated by coordinates (x′, y′). Also, the distance from the imaging lens to the microlens array is indicated by F, and the distance from the imaging lens to the refocus plane is indicated by αF. α is a refocus coefficient for determining the position of the refocus plane and can be arbitrarily set by the user. FIG. 5 shows only the u, x, and x′ directions and does not show any of the v, y, and y′ directions. As shown in FIG. 5, light having passed through the coordinates (u, v) and coordinates (x, y) reaches the coordinates (x′, y′) on the microlens array. The coordinates (x′, y′) are given by:

$$( {x}^{′} , {y}^{′} ) = ( u + \frac{x - u}{a} , v + \frac{y - v}{a} ) \qquad ( 3 )$$

Letting L(x′, y′, u, v) be an output from the pixel which receives this light, an output E(x, y) obtained at the coordinates (x, y) on the refocus plane is an integral of L(x′, y′, u, v) in regard to the pupil area of the imaging lens and is given by:

$$E ( x , y ) = \frac{1}{{a}^{2} {F}^{2}} \int \int L ( u + \frac{x - u}{a} , v + \frac{y - v}{a} , u , v ) d u d v \qquad ( 4 )$$

In equation (4), the refocus coefficient α is determined by the user. Thus, if (x, y) and (u, v) are given, the position (x′, y′) of a microlens which receives light can be obtained. Then, a pixel corresponding to the position (u, v) is obtained from a pixel array 20 corresponding to this microlens. An output from this pixel is L(x′, y′, u, v). This is executed for all pupil division areas, obtained pixel outputs are integrated, and thus E(x, y) can be calculated. If (u, v) are defined as the representative coordinates of a pupil division area of the imaging lens, the integration of equation (4) can be calculated by simple addition.

Image capturing processing and reconstruction processing for a light field image have been explained above. However, a light field image may be acquired from an external device by using the recording unit 115, communication unit 116, or the like, and is not limited to an image obtained by image capturing.

Next, a method of generating a trick art image in the first embodiment of the present invention will be explained.

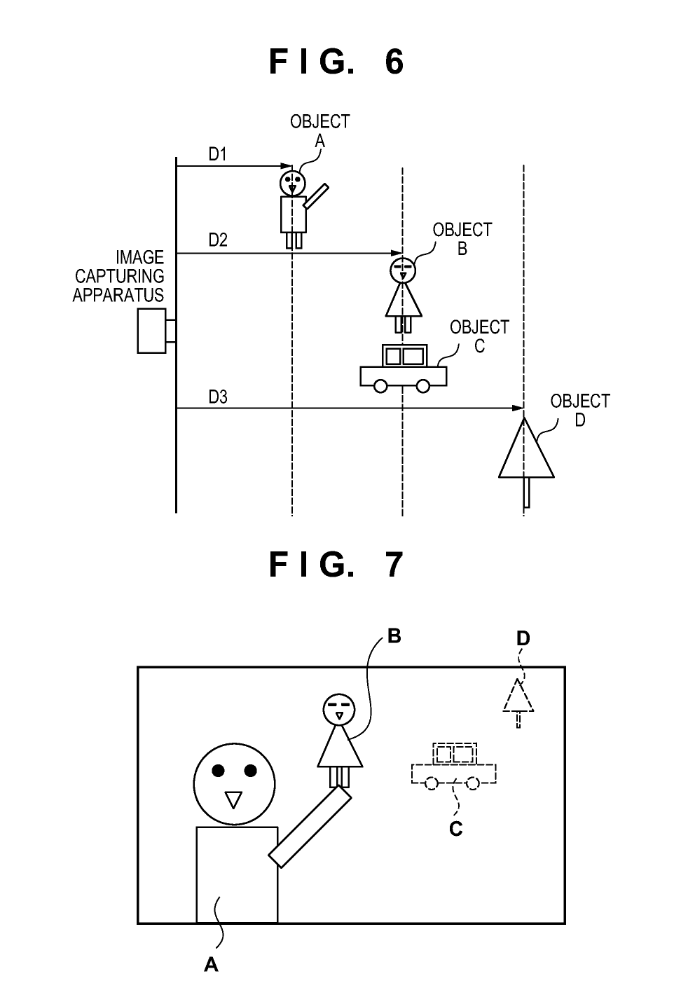

FIG. 6 is a view showing the distance relationship between the image capturing apparatus and objects when capturing a trick art image in the first embodiment. Assume that distances from the image capturing apparatus have a positional relationship in which an object A has a distance D1, objects B and C have a distance D2, and an object D has a distance D3. FIG. 7 is a view showing a generated trick art image in the first embodiment. This trick art image is an image of a composition in which the object B seems to stand on the hand of the object A.

An area except for objects to be used for an illusion effect of a trick art image will be called a background. An image having a great effect of a trick art can be obtained by setting the refocus plane of the background to be equal to that of one of objects to be used for an illusion. In the embodiment, it is desirable to generate an image in which the objects A and B are in focus because they are used for an illusion effect, and the objects C and D included in the background area are not in focus.

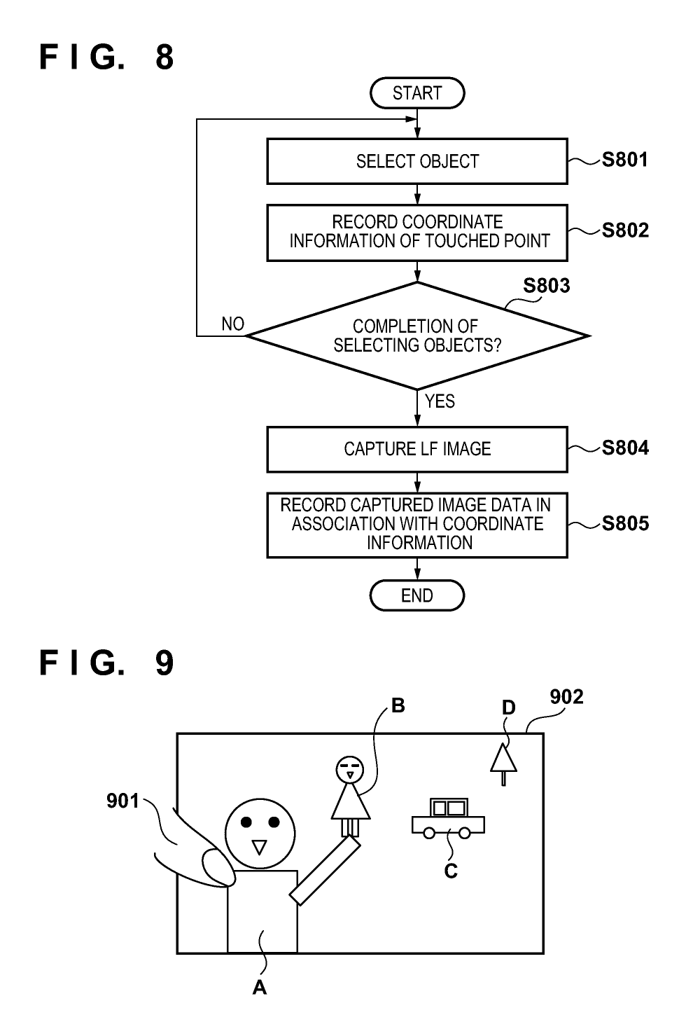

FIG. 8 is a flowchart when capturing images to be used for a trick art in the first embodiment. A mode in which processing to be described in the embodiment is performed will be called a trick art mode.

When the user starts an image capturing operation and selects the trick art mode, he selects objects to be used for a trick art in step S801. The selection operation is performed by operating the touch panel of the display unit 106.

FIG. 9 shows an example of the method of selecting objects in step S801. When the user wants to select the object A, he touches to select, with a finger 901, one point included in the area of the object A on an EVF 902. In step S802, coordinate information (representative coordinate information in captured image data) of the point touched in step S801 is added to the captured image data and recorded in the recording unit 115.

In step S803, it is determined whether selection of all objects to be used for an illusion effect of a trick art has been completed. If the selection has not been completed, the process returns to step S801 to select an object again. If the selection has been completed, the process advances to step S804. This selection operation is completed by a half stroke (so-called SW1) of a shutter button included in the switch group 117.

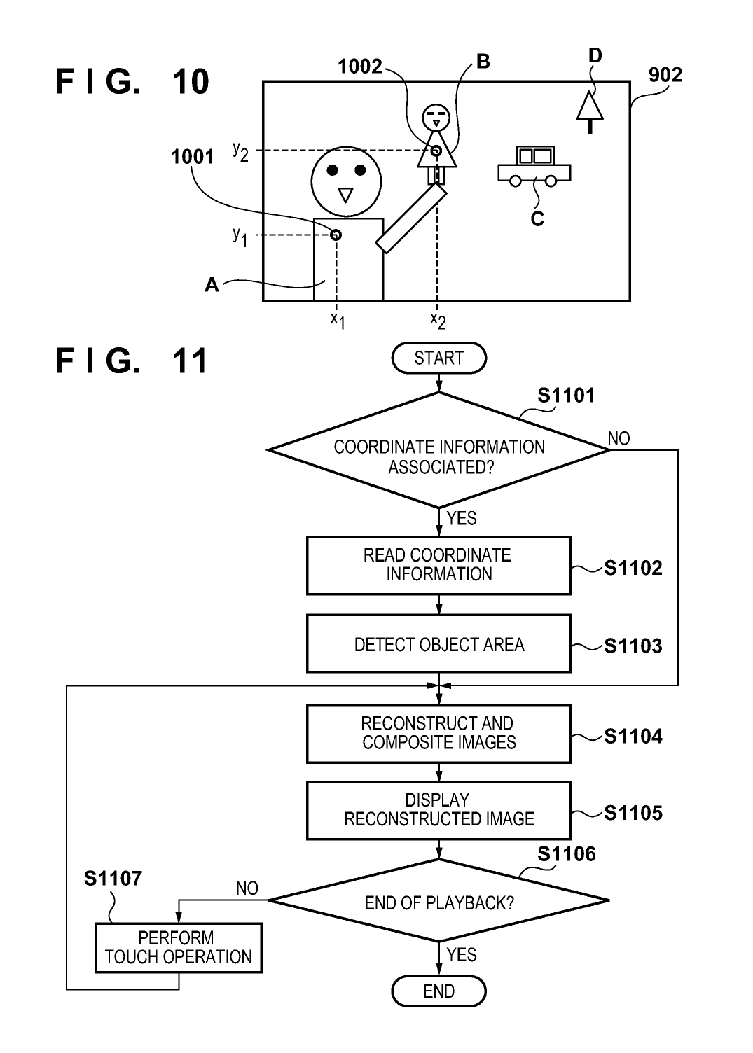

FIG. 10 shows an example of coordinate information held in step S803. When the coordinates of a touched point 1001 on the object A are (x1, y1) on the EVF 902, and those of a touched point 1002 on the object B are (x2, y2), pieces of coordinate information of these two points are recorded in association with the captured image data in step S805.

In step S804, image capturing processing for a light field image is performed by a full stroke (so-called SW2) of the shutter button included in the switch group 117. In step S805, the coordinate information recorded in step S803 is associated as trick art coordinate information with the captured image data obtained in step S804, and recorded in the recording unit 115. The acquisition of captured image data to be used for a trick art image is thus completed.

Subsequently, playback of the image recorded in step S805 will be explained. FIG. 11 is a flowchart showing an operation in playback in the first embodiment.

In step S1101, it is determined whether trick art coordinate information is associated with image data to be played back. If trick art coordinate information is associated, it is determined that image data to be played back is a trick art image, and the process advances to step S1102. If no trick art coordinate information is associated, it is determined that image data to be played back is not a trick art image, and the process advances to step S1104.

In step S1102, the trick art coordinate information associated with the image is read from the recording unit 115. In step S1103, the image processing unit 105 detects object areas to be used for an illusion effect of a trick art by using the trick art coordinate information read in step S1102, and records the result in the recording unit 115. Note that details of the object area detection method will be described later.

In step S1104, the image processing unit 105 reconstructs and composites images based on the detected objects. Note that details of the image reconstruction/composition method will be described later. In step S1105, the reconstructed image is displayed on the EVF.

In step S1106, it is determined whether the playback has ended. The playback ends when the user performs an operation such as selection of the end of the playback mode or a change of an image to be played back. If the user selects the end of the playback, the process ends. If the user does not end the playback, the process advances to step S1107.

In step S1107, the user selects, by a touch operation, an object to be in focus, and then the process advances to step S1104. Processing in step S1104 is performed in accordance with the object selected in step S1107. With this, the description of the operation in playback ends.

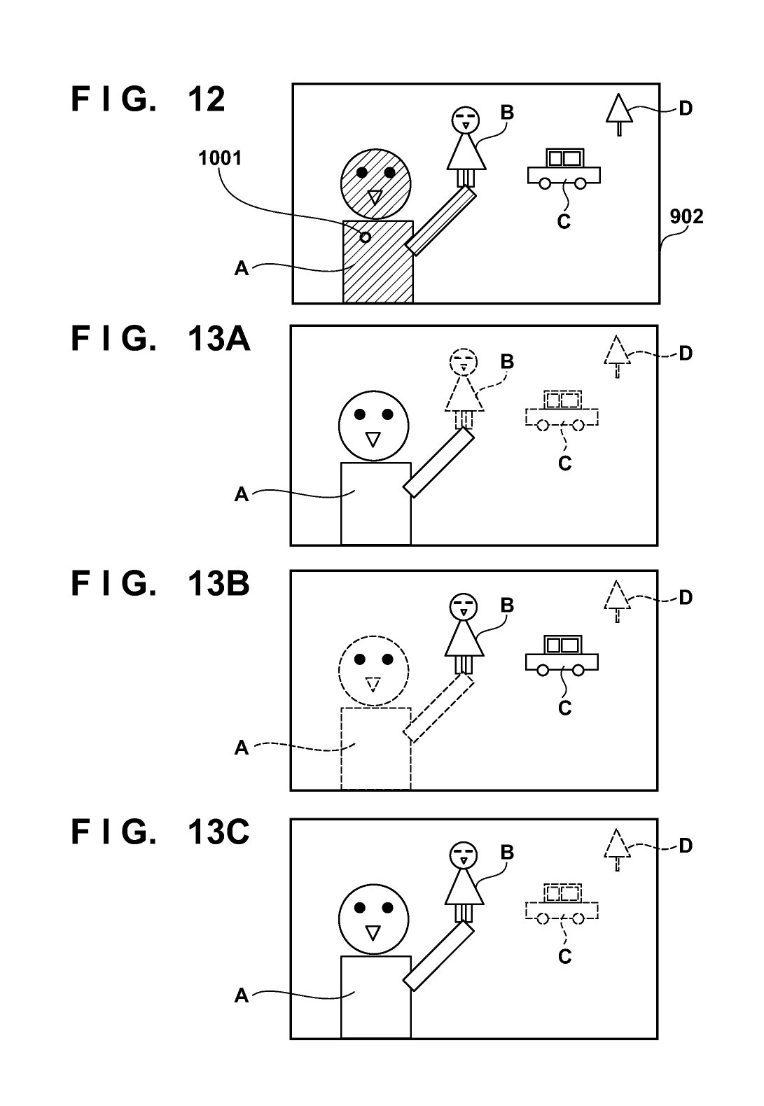

FIG. 12 shows an example of the object area detection method in step S1103. For example, a method of detecting the area of the object A will be explained. First, a reconstructed image in which the periphery of the touched point 1001 is in focus by contrast AF is acquired among reconstructed images obtained by moving the refocus plane of the entire image back and forth. The area of the object A can be detected by performing edge detection for the acquired image. The detected object area information is held by recording all the coordinates of boundaries. Of all detected object areas, an object having a largest area (ratio at which the object occupies the frame) is defined as a representative object. In the embodiment, the object A serves as a representative object.

Next, details of the image reconstruction/composition method in step S1104 will be explained. FIGS. 13A to 13C show examples of an image to be reconstructed and an image obtained by composition in the embodiment. First, an image is reconstructed at the focus position of the representative object. In the embodiment, an image (reference image) reconstructed at the focus position of the object A is acquired. FIG. 13A shows the acquired image.

Then, an image is reconstructed at the focus position of an associated object except for the representative object out of the objects detected in step S1103. When there are a plurality of associated objects except for the representative object, reconstructed images are acquired by the number of associated objects. In the embodiment, an image reconstructed at the focus position of the object B is acquired. FIG. 13B shows the acquired image.

The area of the detected object B is extracted from the acquired image of FIG. 13B, and composited in the same area in FIG. 13A. FIG. 13C shows the image after composition. This concludes the description of the image reconstruction/composition method.

In step S1107, a target to be in focus when reconstructing an image is selected by a touch operation. If the touched portion falls within the associated object area, the touched object is used as a representative object and the above-described image reconstruction/composition is performed. If the touched portion falls outside the associated object area, image reconstruction is performed at the focus position of the touched point.

A modification of the first embodiment will be explained. The object selection operation in step S801 of FIG. 8 and the object selection completion operation in step S803 may be performed using a switch included in the switch group 117.

In FIG. 8, the coordinates of a touched point may track an object in order to prevent the coordinates from deviating from the object when the object moves till recording of information in step S805 after the object is selected in step S801. In this arrangement, the touched coordinate information is not recorded in step S802, and coordinate information after tracking is recorded in step S804.

Detection of the object area in step S1103 of FIG. 11 may include a distance information calculation step and be performed using distance information. Alternatively, the detection may include a physical object recognition/person recognition step and be performed using information obtained in this step. As for an object area range selected in step S1103 of FIG. 11, the range may be colored and displayed on the EVF. In step S1103 of FIG. 11, an object area may be properly detected, as needed, without recording coordinate information.

The representative object determination method in playback may include a distance recognition step, and an object closest to the image capturing apparatus may be adopted as a representative object. Alternatively, this method may include a personal authentication step, and an authenticated object may be set as a representative object. Alternatively, this method may include a person recognition step, and an object which is or is not a person may be set as a representative object. Alternatively, these steps may be combined to determine a representative object.

If a touched portion falls outside an associated object area in step S1107 of FIG. 11, an image which is controlled so all associated objects blur equally may be generated. When playing back again an image reconstructed once, an image displayed at the end of previous playback (step S1106 of FIG. 11) may be displayed.

As described above, an intended trick art image can be easily reconstructed by selecting objects to be used for a trick art and associating them with each other upon image capturing.

### Second Embodiment

As the second embodiment, a case in which recorded captured image data are reconstructed into a trick art image in playback will be described. The arrangement of an image capturing apparatus is the same as that in the first embodiment, and a description thereof will not be repeated. A mode in which processing to be described in the embodiment is performed will be called a trick art playback mode.

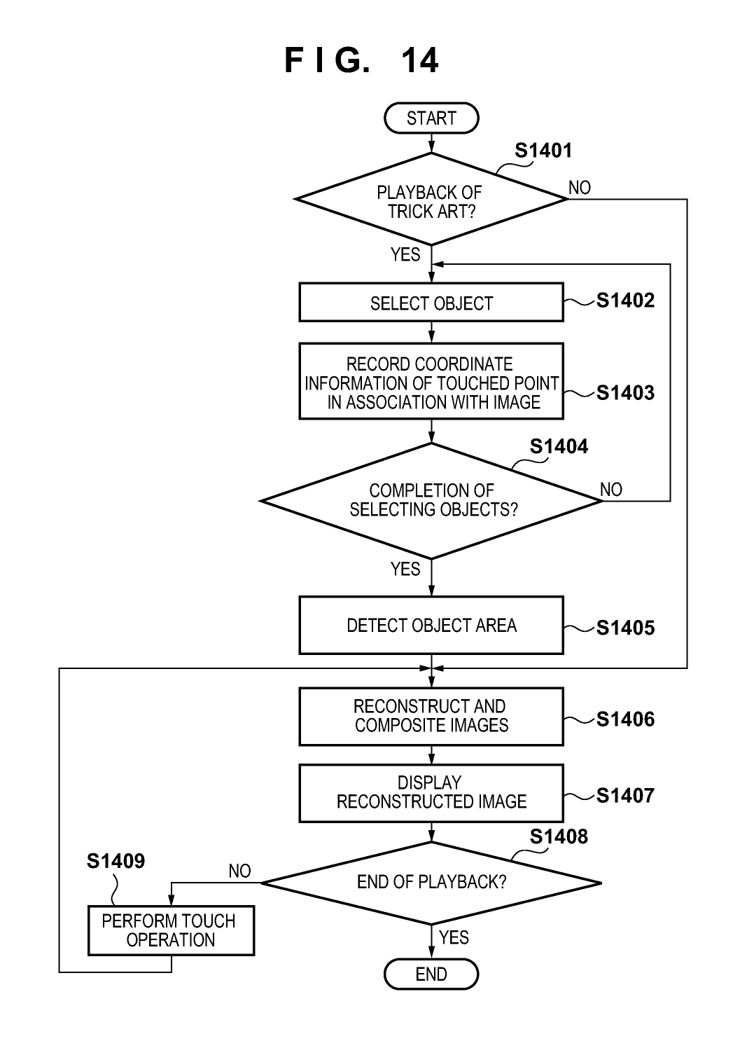

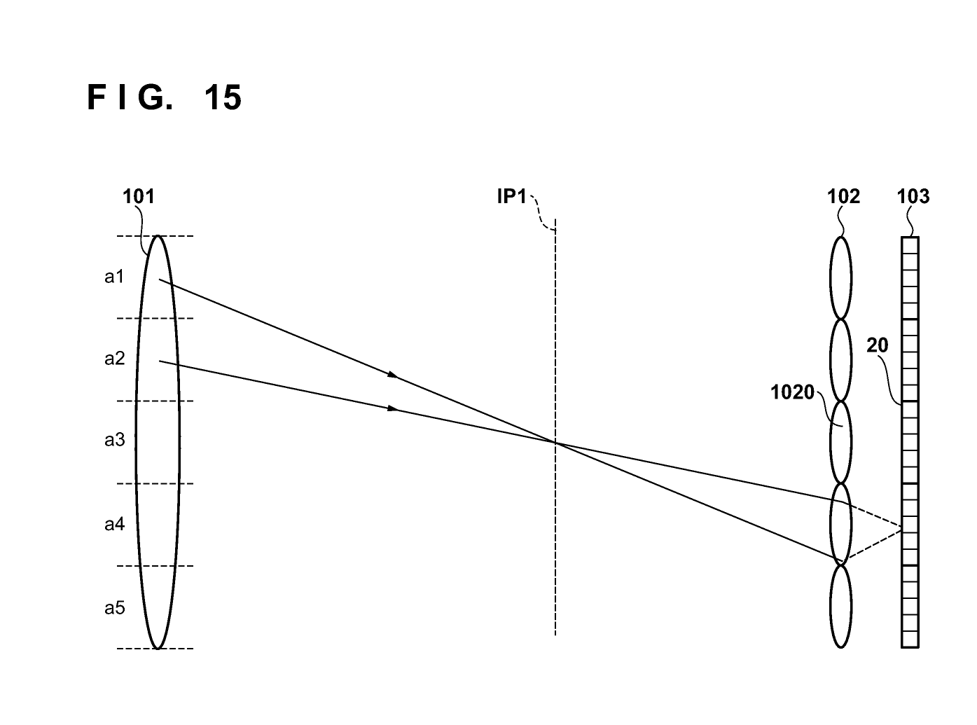

FIG. 14 is a flowchart showing an operation of reconstructing recorded captured image data into a trick art image in playback.

In step S1401, it is determined whether the trick art playback mode has been selected. If the trick art playback mode has been selected, the process advances to step S1402. If the trick art playback mode has not been selected, the process advances to step S1406.

Processing in step S1402 is the same as that in step S801 of FIG. 8, and a description thereof will not be repeated. In step S1403, coordinate information obtained by a touch in step S1402 is associated as trick art coordinate information with the image and recorded in a recording unit 115.

In step S1404, it is determined whether selection of objects has been completed. If the selection has not been completed, the process returns to step S1402 to select an object again. If the selection has been completed, the process advances to step S1405. This selection operation is completed by operating a switch included in a switch group 117. Processes in steps S1405 to S1409 are the same as those in steps S1103 to S1107 of FIG. 11, respectively, and a description thereof will not be repeated.

As described above, according to the second embodiment, captured image data which were not obtained in the trick art mode can be easily reconstructed into an intended trick art image.

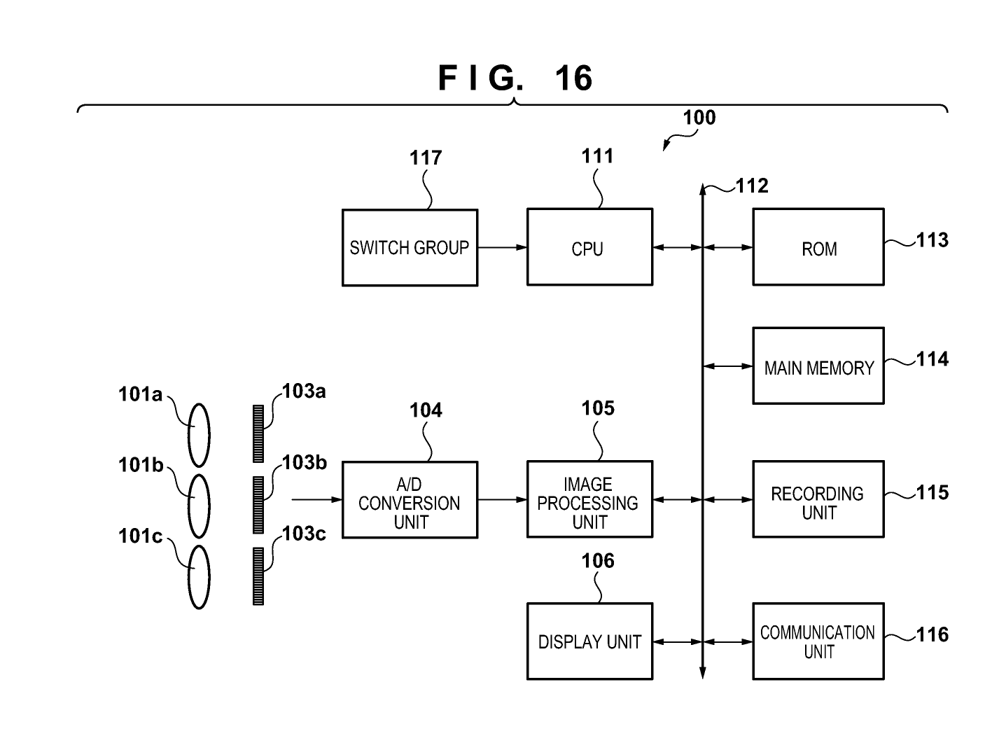

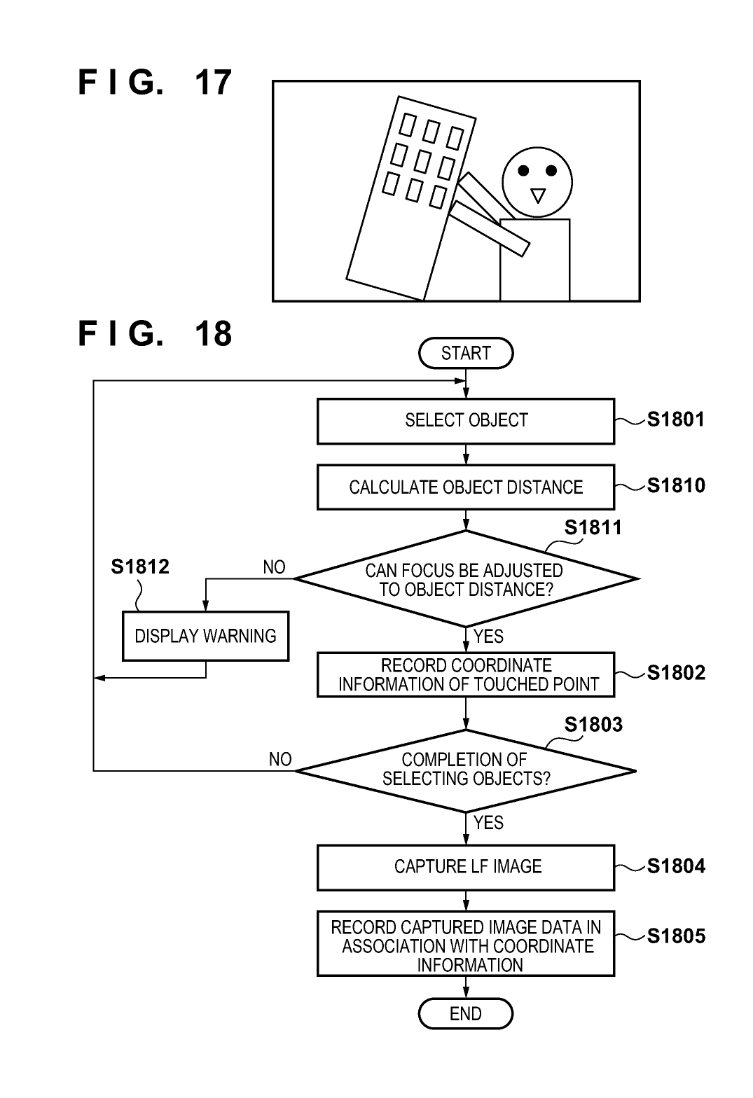

In the first and second embodiments, data acquired by the arrangement of the imaging lens, microlens array, and image sensor shown in FIG. 3 is targeted as refocusable light field data. Instead, light field data acquired by an arrangement shown in FIG. 15 may be used. Details of the arrangement in FIG. 15 are described in “Todor Georgiev, et al., ‘Superresolution with Plenoptic 2.0 Camera’, 2009 Optical Society of America”, and thus will be described in brief. A difference from FIG. 3 is that the main lens of the camera is adjusted to focus on the plane of the microlens array 102 in the arrangement of FIG. 3, but is adjusted to focus on an image plane IP1 in front of the plane of a microlens array 102 in FIG. 15.

In the first and second embodiments, data acquired by the apparatus arrangement shown in FIG. 1 is targeted as refocusable light field data. Instead, light field data acquired by an apparatus arrangement shown in FIG. 16 may be used. In this case, beams refracted by optical systems 101a to 101c are received by corresponding image sensors 103a to 103c. A plurality of images acquired by the image sensors 103a to 103c are parallax images obtained when the object space is observed from different viewpoints. By compositing these images, the two-dimensional intensity distribution and angle information of light in the object space, that is, the light field can be obtained. A method of obtaining a refocus image from a multi-eye camera as shown in FIG. 16 is described in Japanese Patent Laid-Open No. 2011-22796, and a description thereof will be omitted.

### Third Embodiment

The third embodiment of the present invention will be described. The arrangement of an image capturing apparatus is the same as those in the first and second embodiments, and a description thereof will not be repeated. The third embodiment is different from the first embodiment in an operation when capturing an image to be used for a trick art, and only the difference will be explained.

FIG. 18 is a flowchart when capturing images to be used for a trick art in the third embodiment. A mode in which processing to be described in the embodiment is performed will be called a trick art mode, similar to the first embodiment.

When the user starts an image capturing operation and selects the trick art mode, he selects objects to be used for a trick art in step S1801. The selection operation is performed by operating the touch panel of a display unit 106.

The method of selecting objects in step S1801 is the same as the method described with reference to FIG. 9. When the user wants to select an object A, he touches to select, with a finger 901, one point included in the area of the object A on an EVF 902. After that, the process advances to step S1810.

In step S1810, the object distance to the point touched in step S1801 is calculated, and then the process advances to step S1811. The calculation of the distance can use the aforementioned pupil division phase difference, and a description thereof will be omitted.

In step S1811, it is determined whether the focus can be adjusted to the calculated object distance. A detailed determination method will be described later. If the focus can be adjusted to the calculated object distance, the process advances to step S1802; if it cannot be adjusted (outside the refocusable range), to step S1812.

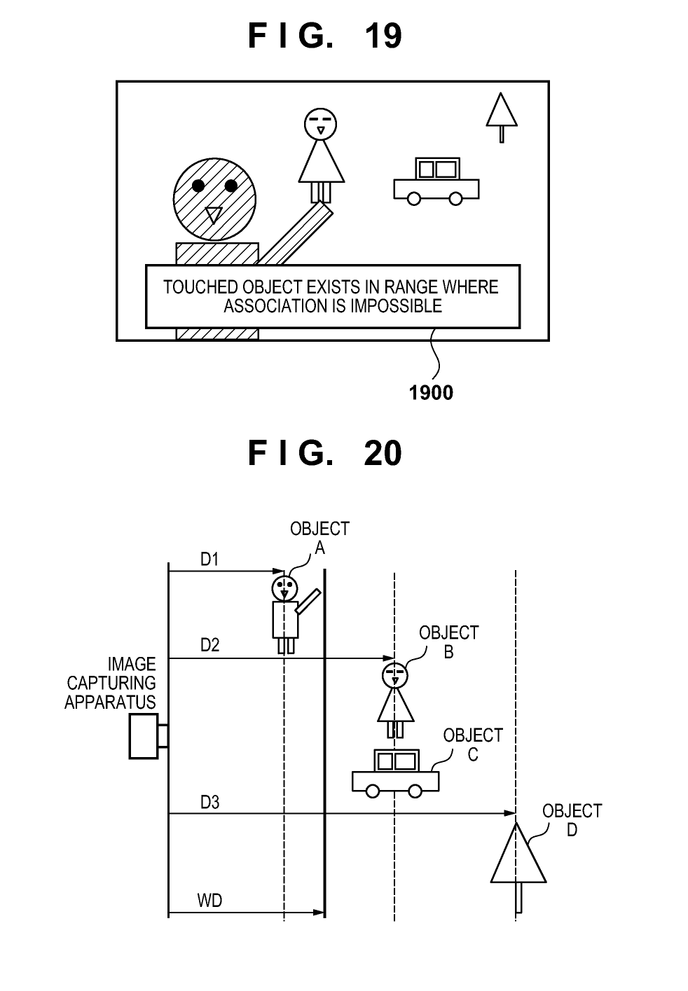

In step S1812, as shown in FIG. 19, the display unit 106 displays a warning message (message) 1900 representing that the selected object exists outside the in-focus range. The process then returns to step S1801 to select an object again.

In step S1802, coordinate information of the point touched in step S1801 is recorded in a recording unit 115. In step S1803, it is determined whether selection of all objects to be used for an illusion effect of a trick art has been completed. If the selection has not been completed, the process returns to step S1801 to select an object again. If the selection has been completed, the process advances to step S1804. This selection operation is completed by a half stroke (so-called SW1) of a shutter button included in a switch group 117.

An example of the coordinate information held in step S1803 is the same as that already described with reference to FIG. 10. When the coordinates of a touched point 1001 on the object A are (x1, y1) on the EVF 902, and those of a touched point 1002 on the object B are (x2, y2), pieces of coordinate information of these two points are recorded in association with the captured image data in step S1805.

In step S1804, image capturing processing for a light field image is performed by a full stroke (so-called SW2) of the shutter button included in the switch group 117. In step S1805, the coordinate information recorded in step S1803 is associated as trick art coordinate information with the captured image data obtained in step S1804, and recorded in the recording unit 115. Accordingly, the acquisition of captured image data to be used for a trick art image is completed.

Next, the method of determining whether the focus can be adjusted to a calculated object distance, as described in step S1811, will be explained in detail with reference to FIG. 20. Let WD be the shortest shooting distance of the image capturing apparatus. Then, if the object distance D and WD satisfy inequality (5) below, the focus cannot be adjusted to the object distance D:

D<WD (5)

Since an object A in FIG. 20 satisfies inequality (5), it is determined that the object A cannot be in focus. In this manner, it can be determined whether the selected object A can be in focus. The method of determining whether an object can be in focus is not limited to the above-described method. For example, when the image capturing apparatus is set to adjust the focus to the vicinity of WD, it can be easily imagined that the focus cannot be adjusted to a long distance such as infinity. Various modifications and changes can therefore be made.

In step S1812, the warning message 1900 is displayed as shown in FIG. 19, but the display method is not limited to this. For example, in addition to the warning message 1900, an object outside an in-focus range may be highlighted, or the user may be instructed to step back slightly. Further, for example, the focus is adjusted to the distance WD, the stop is narrowed down, and an image in which the object A is in focus as much as possible is created to obtain a trick art. In this fashion, various modifications can be made.

As described above, according to the third embodiment, when capturing images to be used for a trick art, if an object to be used for trick art exists outside the in-focus range, the user can be warned and notified of this.

### Fourth Embodiment

The fourth embodiment of the present invention will be described. The arrangement of an image capturing apparatus is the same as those in the first to third embodiments, and a description thereof will not be repeated. The fourth embodiment is different from the second embodiment in an operation in reconstruction into a trick art image in playback, and only the difference will be explained. A mode in which processing to be described in the embodiment is performed will be called a trick art playback mode, similar to the second embodiment.

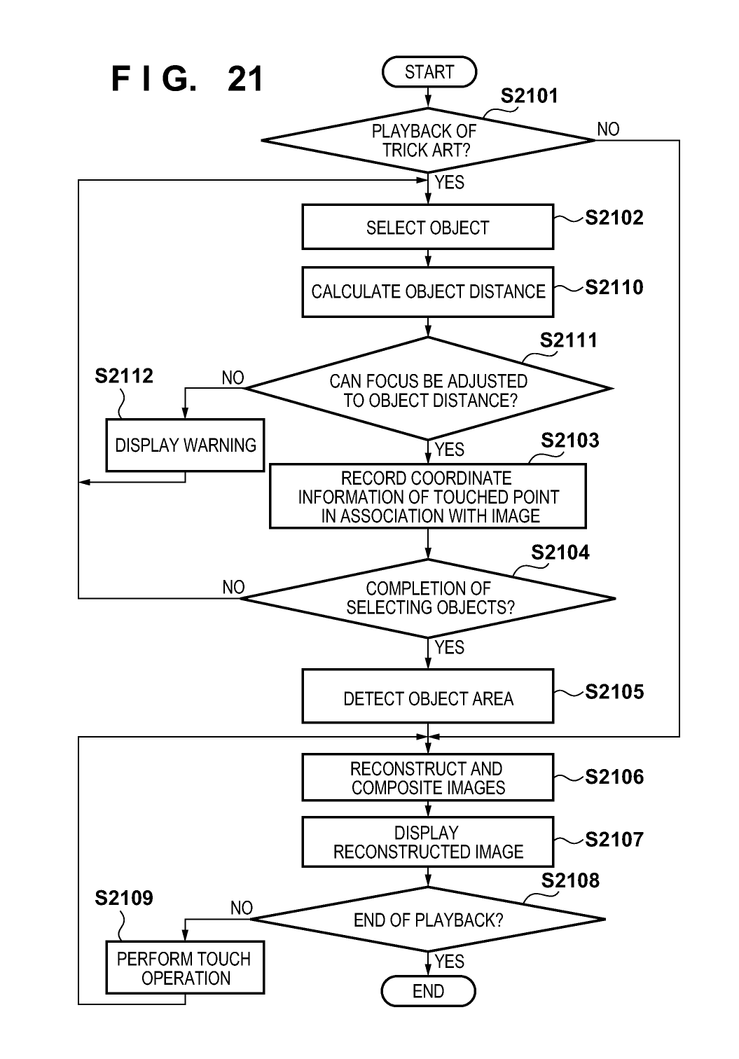

FIG. 21 is a flowchart when reconstructing recorded captured image data into a trick art image in playback.

In step S2101, it is determined whether the trick art playback mode has been selected. If the trick art playback mode has been selected, the process advances to step S2102. If the trick art playback mode has not been selected, the process advances to step S2106.

Processing in step S2102 is the same as that in step S1801 of FIG. 18, and a description thereof will not be repeated. Then, the process advances to step S2110. Processes in steps S2110 to S2112 are the same as those in steps S1810 to S1812 of FIG. 18, respectively, and a description thereof will not be repeated.

In step S2103, coordinate information obtained by a touch in step S2102 is associated as trick art coordinate information with the image and recorded in a recording unit 115.

In step S2104, it is determined whether selection of objects has been completed. If the selection has not been completed, the process returns to step S2102 to select an object again. If the selection has been completed, the process advances to step S2105. This selection operation is completed by operating a switch included in a switch group 117. Processes in steps S2105 to S2109 are the same as those in steps S1103 to S1107 of FIG. 11, respectively, and a description thereof will not be repeated.

As described above, according to the fourth embodiment, captured image data which were not obtained in the trick art mode can be easily reconstructed into an intended trick art image. If an object to be used for an illusion exists outside the in-focus range, the user can be warned and notified of this.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-027141, filed Feb. 14, 2013, which is hereby incorporated by reference herein in its entirety.

What is claimed is:

1. An image capturing apparatus comprising:
an image capturing unit configured to capture an image and generate light field image data;
a selection unit configured to select an object from the captured image data;
an associating unit configured to associate a plurality of objects selected by said selection unit;
a reconstruction unit configured to reconstruct a plurality of images in which the plurality of objects associated by said associating unit are in focus, respectively; and
a composition unit configured to composite the plurality of images reconstructed by said reconstruction unit.

2. The apparatus according to claim 1, wherein said selection unit includes an operation member configured to be operated by a user.

3. The apparatus according to claim 2, wherein the operation member includes a touch panel.

4. The apparatus according to claim 1, wherein said selection unit tracks motion of an object.

5. The apparatus according to claim 1, further comprising a display unit configured to color and display an object selected by said selection unit.

6. The apparatus according to claim 1, further comprising a recording unit configured to add representative coordinate information in the light field image data of an object selected by said selection unit to the captured image data, and record the representative coordinate information.

7. The apparatus according to claim 1, wherein a reconstructed image in which an object occupying the light field image data at a highest ratio among objects selected by said selection unit is set as a refocus plane is used as a reference image when compositing the plurality of images.

8. The apparatus according to claim 1, wherein a reconstructed image in which an object closest to the image capturing apparatus among objects selected by said selection unit is set as a refocus plane is used as a reference image when compositing the plurality of images.

9. The apparatus according to claim 1, wherein a reconstructed image in which an object successful in personal authentication among objects selected by said selection unit is set as a refocus plane is used as a reference image when compositing the plurality of images.

10. The apparatus according to claim 1, wherein a reconstructed image in which an object recognized as a person among objects selected by said selection unit is set as a refocus plane is used as a reference image when compositing the plurality of images.

11. The apparatus according to claim 1, wherein a reconstructed image in which an object not recognized as a person among objects selected by said selection unit is set as a refocus plane is used as a reference image when compositing the plurality of images.

12. The apparatus according to claim 1, wherein the image capturing unit comprises a microlens array and an image sensor, and each microlens of the microlens array corresponds to a plurality of pixels of the image sensor.

13. The apparatus according to claim 1, further comprising:
a calculation unit configured to calculate a distance from the image capturing apparatus to an object selected by said selection unit; and
a warning unit configured to, when an object associated by said associating unit exists outside a refocusable range of the image capturing apparatus, notify a user that the object cannot be in focus.

14. The apparatus according to claim 13, wherein the outside of the refocusable range represents that the distance to the object that is calculated by said calculation unit is shorter than a shortest shooting distance of the image capturing apparatus.

15. The apparatus according to claim 13, wherein said warning unit displays a warning message.

16. The apparatus according to claim 13, wherein said warning unit highlights the object outside the refocusable range.

17. The apparatus according to claim 13, wherein said warning unit displays a message which prompts a user to move.

18. A method of controlling an image capturing apparatus including an image capturing unit configured to capture an image and generate light field image data, comprising:
a selection step of selecting an object from the captured image data;
an associating step of associating a plurality of objects selected in the selection step;
a reconstruction step of reconstructing a plurality of images in which the plurality of objects associated in the associating step are in focus, respectively; and
a composition step of compositing the plurality of images reconstructed in the reconstruction step.

19. The method according to claim 18, further comprising:
a calculation step of calculating a distance from the image capturing apparatus to an object selected in the selection step; and
a warning step of, when an object associated in the associating step exists outside a refocusable range of the image capturing apparatus, notifying a user that the object cannot be in focus.
